(19) United States
(12) Patent Application Publication
(10) Pub. No.: US 2020/0029505 A1
(43) Pub. Date: Jan. 30, 2020

(54) METHOD AND APPARATUS FOR PLANTING

(71) Applicant: Mitchell Riley, Dillonvale, OH (US)

(72) Inventor: Mitchell Riley, Dillonvale, OH (US)

(21) Appl. No.: 16/516,402

(22) Filed: Jul. 19, 2019

Related U.S. Application Data
(60) Provisional application No. 62/702,630, filed on Jul. 24, 2018.

(51) Int. Cl. A01G 9/02

(52) U.S. Cl. CPC A01G 9/028; A01G 2009/003

(57) ABSTRACT

A planter having multiple growth chambers accessible by the root system of a plant disposed therein via the removal of one or more dividers and a method of use therefor is provided. The planter may further include a drainage system to remove excess water from the soil while keeping separate volumes of soil dry until being utilized by the plant being grown therein.

### CROSS REFERENCE TO RELATED APPLICATIONS

This application claims the benefit of U. S. Provisional Application Ser. Number 62/702,630, filed on Jul. 24, 2018; the disclosure of which is incorporated herein by reference.

### BACKGROUND

### Technical Field

The present disclosure relates generally to planters. More specifically, the present disclosure relates to a planter having multiple chambers for holding soil to allow for growth of a plant within a single container. Specifically, the present disclosure relates to a planter having multiple chambers separated by removable dividers that can allow a plant to grow through varying layers of nutrient rich soil containing within a single planter.

### Background Information

When starting a plant from a seed or seedling, it is common practice to place the seed or seedling in a small container with soil and nutrients to allow the plant the best opportunity to gain a foothold and begin to grow. This can increase the likelihood of getting a viable plant from the seed or seedling as it is not exposed to seed predation and the levels of nutrients and water can be controlled easily. However, as plants grow, they need more room for their root system to expand or else the growth of the plant will be limited in size and, in the case of fruit and vegetable plants, production of the plant.

Therefore, in traditional systems, as a plant outgrows its first container, the entire plant, including the root ball and soil, is typically removed from the first planter and placed in a second planter of a larger size. In the second planter, a different nutrition course is often applied as the plant has now established a root system and needs different nutrients to continue its growth pattern.

As the plant continues to grow, the plant is typically stepped up through transfers into a series of larger containers, each one having more soil volume and/or different nutrition courses for the plant. If the plant is a long-lived plant, such as a tree being grown from a sapling, the final stage of growth can be to transplant the plant from the last planter to its permanent home, such as its permanent place in a landscape. This process, while effective, can cause damage to the plant's root system at each transfer between planters, which can both damage the plant and stunt growth and/or fruit and vegetable production. For long term plants, this root damage can result in difficulty transferring to a permanent plant location, as well as long-term growth issues. For short term plants, for example a fruit plant such as a tomato plant, this can reduce the production of fruit and stunt the growth of the plant, resulting in a lower fruit yield per growing season.

Further, this system of multiple planters requires a series of larger planters for every plant being grown which can increase the footprint of each individual plant, as each planter needs to be stored when not in use, as well as maintained throughout its life. Alternatively, it is common for growers to utilize inexpensive and flimsy pots that can allow the grower to cut or otherwise remove the bottom of the pot to transfer the plant to the next stage. This destroys the pot and makes it unsuitable for re-use, while creating additional expense and waste.

### SUMMARY

Issues continue to remain with the current planting systems using multiple containers of varying size to take a plant from a seedling or seed to a mature plant. The present disclosure attempts to remedy these and other issues by providing, in one aspect, a planter having multiple chambers separated by removable dividers which can allow the plant to be transferred from a smaller volume of soil into successively larger volumes of soil without disturbing or uprooting the plant for each transfer.

In one aspect, the present disclosure may provide an apparatus for planting comprising: a first side having a first side edge, a second side edge, a top edge, and a bottom edge; a second side having a first side edge connected to the second side edge of the first side, a second side edge, a top edge, and a bottom edge; a third side having a first side edge connected to the second side edge of the second side, a second side edge, a top edge, and a bottom edge; a fourth side having a first side edge connected to the second side edge of the third side, a second side edge connected to the first side edge of the first side, a top edge, and a bottom edge; wherein the first side, second side, third side, and fourth sides define a four-sided planter having an interior and an exterior; and at least one removable divider inserted through a slot defined through the first side, the divider operable to engage a channel within the interior of the planter to divide the interior into at least two separate chambers.

In another aspect, the present disclosure may provide a method of growing a plant comprising: inserting a second removable divider into a planter to form a second portion of an interior chamber of the planter; filling the second portion of the planter with a second volume of soil; inserting a first removable divider above the second volume of soil to isolate the second volume of soil from the remaining unfilled portion of the interior chamber and to form a first portion of the interior chamber of the planter; filling the first portion of the interior chamber of the planter with a first volume of soil; planting a plant in the first volume of soil; watering the plant with sufficient volume to promote growth of the plant; removing the first divider from the planter when the plant grows to a first size; allowing plant to continue to grow into the second volume of soil; watering the plant with sufficient volume to promote continued growth of the plant; removing the second divider when the plant grows to a second size; and releasing the first and second volumes of soil and the plant from the interior of the planter.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front left perspective view of a first embodiment of a planter of the present disclosure.

FIG. 2 is a left side elevation view of the first embodiment of a planter of the present disclosure.

FIG. 3 is a front left perspective exploded view of the first embodiment of a planter of the present disclosure.

FIG. 4 is a rear right side perspective view of the first embodiment of a planter of the present disclosure.

FIG. 5 is a rear cross-sectional view of the first embodiment of a planter of the present disclosure taken along the line indicated in FIG. 2.

FIG. 6 is a left side cross-section view of the first embodiment of a planter of the present disclosure taken along the line indicated in FIG. 5.

FIG. 7 is a deeper side cross-sectional view of the first embodiment of a planter of the present disclosure taken along the line indicated in FIG. 5.

FIG. 8 is a front left side perspective view of a second embodiment of a planter of the present disclosure.

FIG. 9 is a front left side perspective view of the second embodiment of a planter of the present disclosure.

FIG. 10 is a front left side perspective view of the first embodiment of a planter of the present disclosure.

FIG. 11 is a front left perspective view of a third embodiment of a planter of the present disclosure.

FIG. 12 is a left side cross-section view of the third embodiment of a planter of the present disclosure taken along the line indicated in FIG. 11.

FIG. 13 is a front left perspective view of the third embodiment of a planter of the present disclosure showing a removable drainage system.

FIG. 14 is a rear perspective view of the removable drainage system of the present disclosure.

FIG. 15 is a front left perspective view of the third embodiment of a planter of the present disclosure showing the removable drainage system installed on the planter.

FIG. 16 is a left side cross-section view of the third embodiment of a planter of the present disclosure with the removable drainage system installed taken along the line indicated in FIG. 15.

FIG. 17 is a front cross-section view of the third embodiment of a planter of the present disclosure with the removable drainage system installed taken along the line indicated in FIG. 16.

FIG. 18 is a front left perspective view of a divider of the third embodiment of a planter of the present disclosure.

FIG. 19 is a front cross-section view of the divider of the third embodiment of a planter of the present disclosure taken along the line indicated in FIG. 18.

FIG. 19A is a front cross-section view of an alternate embodiment of the divider of the third embodiment of a planter of the present disclosure.

FIG. 19B is a front cross-section view of an alternate embodiment of the divider of the third embodiment of a planter of the present disclosure.

FIG. 19C is a front cross-section view of an alternate embodiment of the divider of the third embodiment of a planter of the present disclosure.

FIG. 20 is a left side elevation cross-sectional operational view of the first embodiment of a planter of the present disclosure.

FIG. 21A is a left side cross-section operational view of the first embodiment of a planter of the present disclosure.

FIG. 21B is a left side cross-section operational view of the first embodiment of a planter of the present disclosure.

Similar numbers refer to similar parts throughout the drawings.

### DETAILED DESCRIPTION

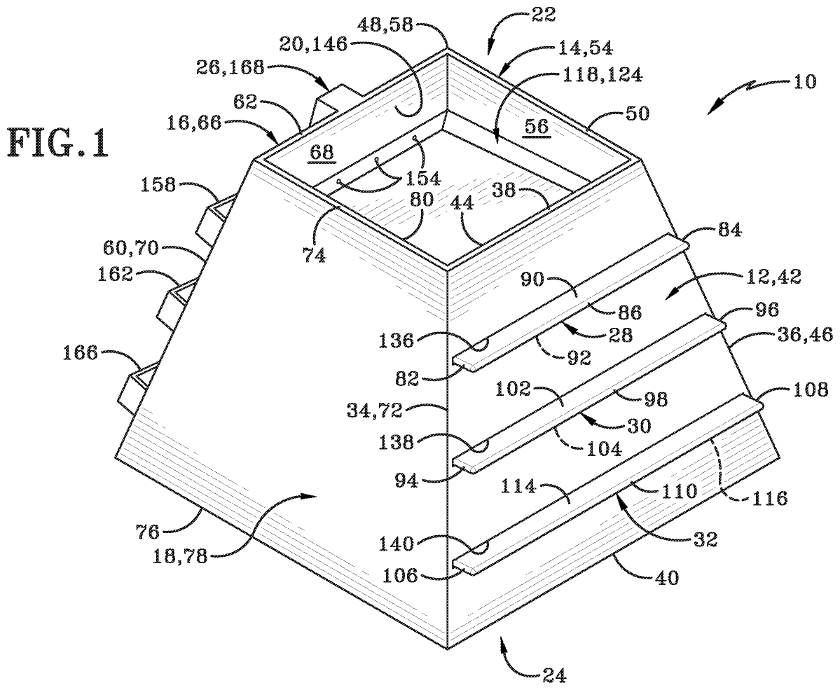

With reference to FIGS. 1-7, planter 10 is shown and may include a first side 12, a second side 14, a third side 16, and a fourth side 18. Planter 10 can further include an interior 20, a top 22, and a bottom 24. Planter 10 may further include a drainage system 26, a first divider 28, a second divider 30, and a third divider 32.

First side 12 of planter 10 may have a first side edge 34 spaced apart from a second side edge 36 defining therebetween a longitudinal direction. First side 12 may further include a top edge 38 spaced apart from a bottom edge 40 therebetween defining a vertical direction. First side 12 may also have an outer face 42 and an inner face 44 defining therebetween the thickness of first side 12.

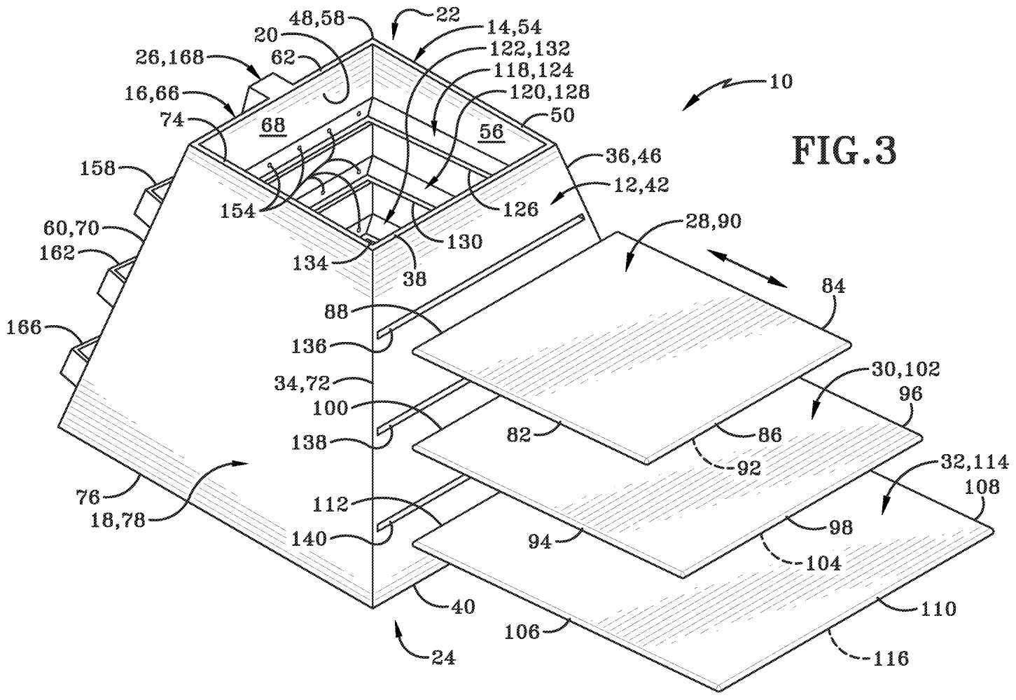

First side 12 may further define first slot 136, second slot 138, and third slot 140. Slots 136, 138, and 140 can be cut through first side 112 creating an opening extending from outer face 42 through inner face 44. Slots 136, 138, and 140 can extend longitudinally across first side 12 as best seen in FIG. 3 and further discussed below.

Second side 14 of planter 10 may have a first side edge 46 longitudinally spaced apart from a second side edge 48; a top edge 50 vertically spaced apart from a bottom edge 52; and an outer face 54 spaced apart from an inner face 56 defining therebetween the thickness of second side 14.

Third side 16 may likewise include a first side edge 58 spaced longitudinally apart from a second side edge 60; a top edge 62 spaced vertically apart from a bottom edge 64; and an outer face 66 spaced apart from an inner face 68 defining therebetween the thickness of third side 16.

Fourth side 18 may also include a first side edge 70 spaced longitudinally apart from a second side edge 72; a top edge 74 spaced vertically apart from a bottom edge 76; and an outer face 78 spaced apart from an inner face 80 defining therebetween the thickness of third side 18.

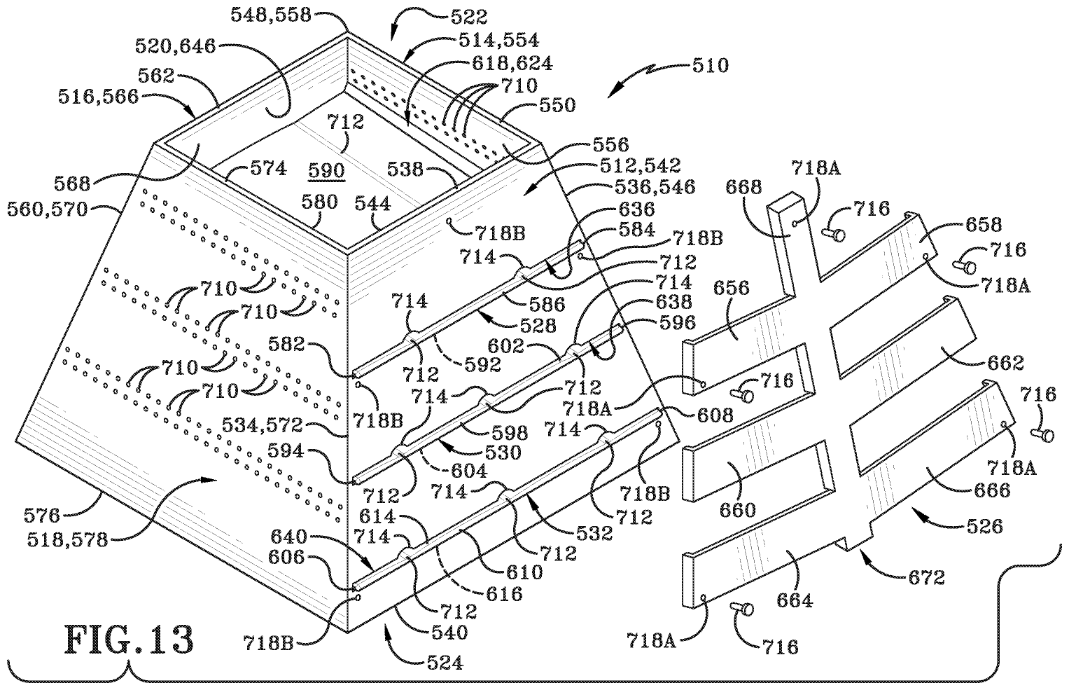

First, second, third, and/or fourth sides 12, 14, 16, and/or 18 may include one or more aeration apertures (such as aeration apertures 710, discussed below with regards to planter 510—e.g. see FIG. 13) defined therethrough to allow air to mix with the soil contained within planter 10 as well as to allow for evaporation of excess moisture that does not drain from the planter 10 and is not absorbed by the root system of the plant contained therein, as discussed below.

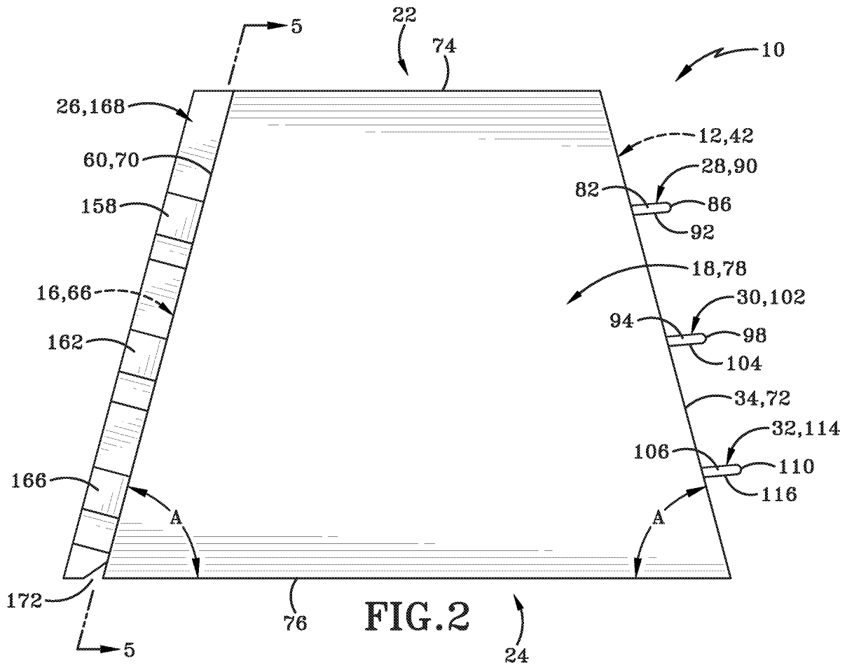

First, second, third, and fourth sides 12, 14, 16, and 18, may generally take a trapezoidal shape wherein the top edges 38, 50, 62, and 74 are parallel to, but have a length less than, bottom edges 40, 52, 64, and 76. According to one aspect, as best seen in FIG. 2 with fourth side 18 shown as a representative example, the angle A between bottom edge 76 and side edges 70 or 72 can be any suitable angle between 1° and 90°. In most applications, the most suitable angle A between bottom edge 76 and side edges 70 or 72 may be within a range of approximately 45° to 80°. According to one aspect, this angle A may be approximately 75 degrees.

The trapezoidal shape of first, second, third, and fourth sides 12, 14, 16, and 18, can give planter 10 an overall four-sided pyramid shape when assembled. Specifically, first side edge 34 of first side 12 can be connected to second side edge 72 of fourth side 18 while second side edge 36 of first side 12 can be connected to first side edge 46 of second side 14. Similarly, second side edge 48 of second side 14 can be connected to first side edge 58 of third side 16 while second side edge 60 of third side 16 can be connected to first side edge 70 of fourth side 18, thereby completing the four-sided pyramid shape planter 10.

According to one aspect, sides can be connected to one another through any means as chosen by a person skilled in the art including but not limited to brackets, bolts, adhesives, nails, screws, or other fasteners. According to another aspect, planter 10 can be manufactured as a single unit having all four sides 12, 14, 16, and 18 formed as a continuous piece. According to another aspect, sides 12, 14, 16, and/or 18 may be formed with and connected through friction/snap tabs, slots, or other similar connections that allow the sides 12, 14, 16, and/or 18 to remain in their relative positions without utilizing further fasteners.

As discussed and disclosed herein, planter 10 can have a four-sided pyramidal shape. This pyramidal shape may provide an advantage to planter 10 in that the lower sections (e.g. third chamber 150, and/or fourth chamber 152) may have a larger capacity and more room for the roots of the plant to expand for later growth stages, as discussed below. It will be understood, however, that many features and components of planter 10 could be readily adapted for use in planters of varying shapes without deviation of the scope herein. By way of a few non-limiting examples, planter 10 may have a three-sided pyramidal shape, a square shape, a rectangular shape, a square shape, a cylindrical shape, an inverted pyramidal shape, or any other suitable and/or desirable shape. According to one aspect, planter 10 may be square or rectangular shaped which may reduce manufacturing costs as the sides 12, 14, 16, and/or 18 may be mass produced and/or produced from a single continuous sheet of material.

Interior 20 of planter 10 can further include a first channel 118, a second channel 120, and a third channel 122 configured to slidably engage first divider 28, second divider 30, and third divider 32, respectively. Specifically, first channel 118 can have a top portion 124 spaced apart from bottom portion 126 in a vertical direction by a distance equal to, or slightly larger than, the thickness of first divider 28, defined as the separation distance between top face 90 and bottom face 92 of first divider 28. The top portion 124 and bottom portion 126 of first channel 118 can thereby define an open channel to accept first divider 128 as it slides through slot 136 and into interior 20 and to secure to first divider 28 within interior 20 of planter 10. Top portion 124 and bottom portion 126 can extend longitudinally along inner face 44 of first side 12 and inner face 56 of second side 14 and inner face 68 of third side 18 thereby creating a three-sided channel 118 while slot 136 can engage a portion first divider 128 such that the forwardmost end and forward edge 86 of first divider 28 extends exterior of first side 12.

Similarly, second channel 120 can have a top portion 128 spaced vertically apart from a bottom portion 130. Top portion 128 and bottom portion 130 can extend longitudinally along inner faces 44, 56, and 68 of first, second, and third sides 12, 14, and 16 with slot 138 engaging the forwardmost portion of second divider 30.

As with first and second dividers 28 and 30, and first and second channels 118 and 120, third channel 122 can likewise include a top portion 132 and a bottom portion 134 extending longitudinally along inner faces 44, 56, and 68 of first, second, and third side with slot 140 configured to engage the forwardmost portion end of third divider 32 with forward edge 110 extending exterior of first side 12.

Interior 20 of planter 10 may further define weep holes 154 that can extend through one or more of first, second, third, or fourth sides 12, 14, 16, and 18. Weep holes 154 can be configured to allow excess water to drain from first chamber 146, second chamber 148, third chamber 150, and/or fourth chamber 152.

According to one aspect, weep holes 154 can be formed through top portions 124, 128, and 132 of first, second, and third channels 118, 120, and 122. According to another aspect, weep holes 154 can be formed through third side 16, and can be configured to allow water to drain into drainage system 26 as discussed further below.

With reference to FIG. 3, first divider 28 can have a left side edge 82 spaced apart from a right side edge 84 in the longitudinal direction, a front side edge 86 spaced apart from a back side edge 88 defining therebetween a horizontal direction, and a top face 90 spaced apart from bottom face 92 in the vertical direction.

Second divider 30 can likewise have a left side edge 94 spaced longitudinally apart from a right side edge 96, a front side edge 98 spaced horizontally apart from a back side edge 100, and a top face 102 spaced vertically apart from a bottom face 104.

Third divider 32 may also include a left side edge 106 spaced longitudinally apart from a right side edge 108, a front side edge 110 spaced horizontally apart from a back side edge 112, and a top face 114 spaced vertically apart from a bottom face 116.

First, second, and third dividers 28, 30, and/or 32 can generally have a rectangular shape and can be configured to insert through first side 12 via first slot 136, second slot 138, and third slot 140, respectively. This can allow first divider 28, second divider 30, and third divider 32 to pass into interior 20 of planter 10 thereby creating a first chamber 146, a second chamber 148, a third chamber 150, and a fourth chamber 152. Specifically, first chamber 146 can be the uppermost portion of interior 20 of planter 10 and can be defined by the inner faces 44, 56, 68, and 80 of first, second, third, and fourth sides 12, 14, 16, and 18 and the top face 90 of first divider 28. Second chamber 148 can be immediately below first chamber 146 and can be made up of bottom face 92 of first divider 28, a second portion of the inner face 44, 56, 68, and 80 of first, second, third, and fourth sides 12, 14, 16, and 18, and the top face 102 of second divider 30. Third chamber 150 can be immediately below second chamber 148 and can be made up of bottom face 104 of second divider 30, a third portion of inner faces 44, 56, 68, and 80 of first, second, third, and fourth sides 12, 14, 16, and 18, and top face 114 of third divider 32. Fourth chamber 152 can be directly below the third chamber 150 and can be made up of a fourth portion of the inner faces 44, 56, 68, and 80 of first, second, third, and fourth sides 12, 14, 16, and 18 and the bottom face 118 of third divider 32.

According to one aspect, bottom 24 of planter 10 can be enclosed thereby sealing fourth chamber 152 from the exterior environment. According to another aspect, bottom 24 of planter 10 can be open thereby leaving fourth chamber 152 open as well. Similarly, top 22 of planter 10 can be open thereby exposing the first chamber 146 to the outside environment.

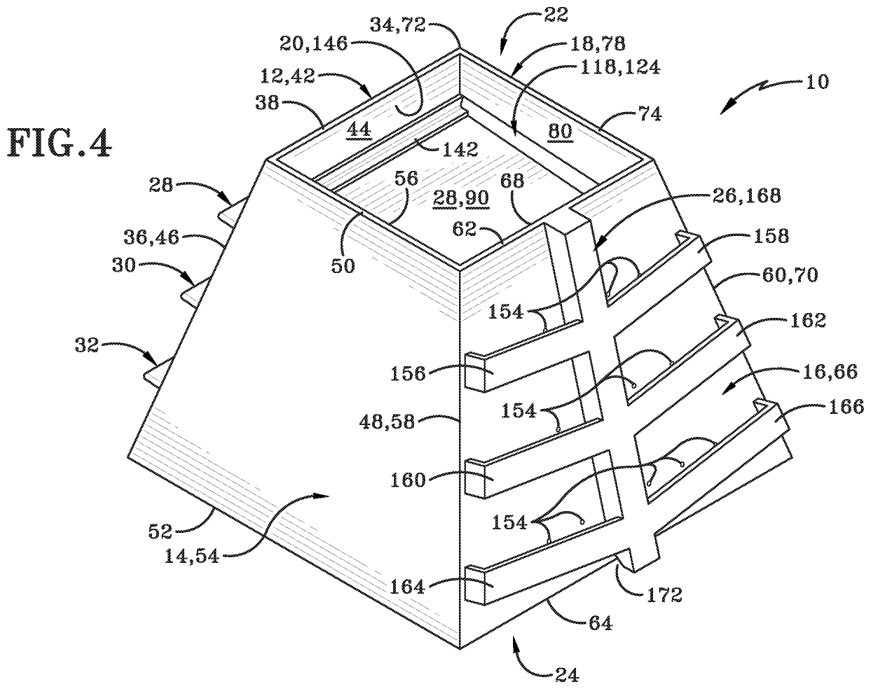

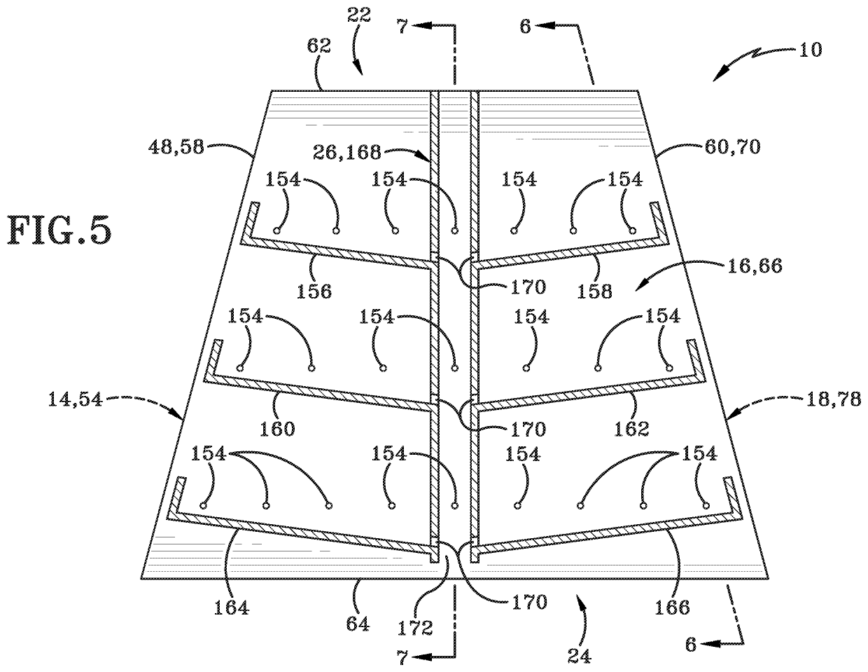

With reference to FIG. 4 and FIG. 5, drainage system 26 is shown and can include a first left branch 156, and first right branch 158, a second left branch 160, a second right branch 162, a third left branch 164, and a third right branch 166. Drainage system 26 can further include a center drain line 168. Center drain line 168 can further define a series of drain holes 170, and a drain opening 172 at or near the bottom of the center drain line 168.

As best seen in FIG. 5, weep holes 154 can extend through third side 16 and can be positioned above each of the first left and right branches 156 and 158, the second left and right branches 160 and 162, and the third left and right branches 164 and 166. Weep holes 154 may optionally be located within center drain line 168. As discussed further below, water can exit interior 20 of planter 10 through weep holes 100 and into the first left and right branch 156, 158, the second left and right branch 160 and 162, and the third left and right branch 164 and 166. These branches 156, 158, 160, 162, 164, and 166 can be sloped towards center drain line 168 to allow water exiting weep holes 154 to drain through drain holes 170 and into center drain line 168. Water can then travel through center drain line 168 down and out drain opening 172 which can be located at the base of drainage system 26.

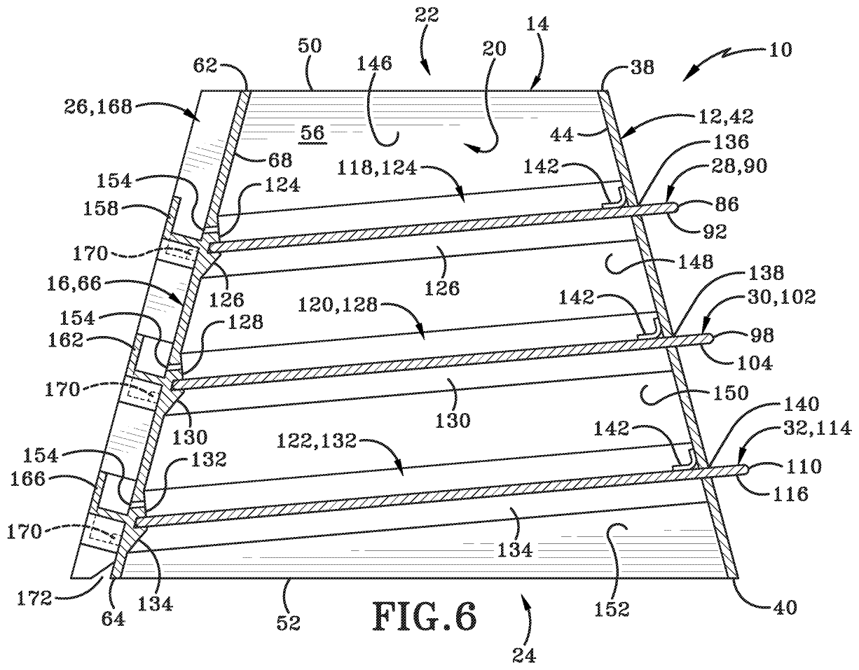

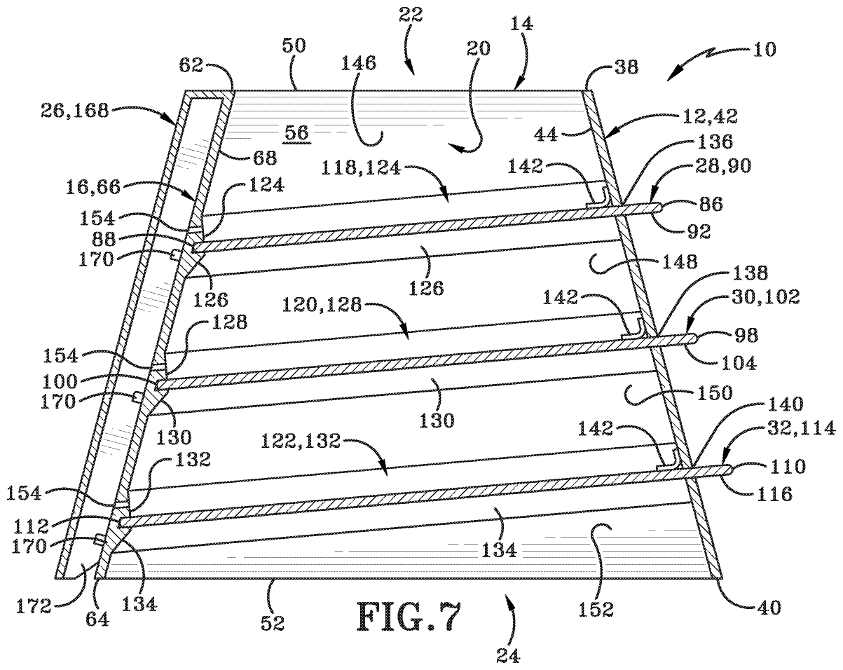

According to one aspect, drainage system 26 and branches 156, 158, 160, 162, 164, and 166 can have side walls and a rear wall to help direct the flow of water as discussed further below. With reference to FIG. 6 and FIG. 7, and according to one aspect, first, second, and third channels can be sloped relative to first, second, third, and fourth sides such that the front edge 86, 98, and 110 of first, second, and third dividers 28, 30, and 32 can be higher than the back edge 88, 100, and 112 of first, second, and third dividers 28, 30, and 32. According to one aspect, the first, second, and third channels 118, 120, and 122 and first, second, and third dividers 28, 30, and 32 can have a slope relative to a horizontal base plane, as measured from back edges 88, 100, and 112, to front edges 86, 98, and 110, respectively, in a range from 1° to 10°. According to another aspect, this slope may be 5°.

With further reference to FIG. 6 and FIG. 7, the cross-section of first channel, second channel, and third channel 118, 120, and 122, particularly as seen relative to third side 16, shows that top portion 124, 128, and 132 of first channel, second channel, and third channel 118, 120, and 122 can extend into interior a first distance while bottom portion 126, 130, and 134 can extend into interior 20 a second distance which can be greater than the distance the top portions 124, 128, and 132 extend. This can provide a shelf-like structure within first, second, and third channels 118, 120, and 122, upon which first, second, and third dividers 28, 30, and 32 can rest thereby adding structural support to the dividers 28, 30, and 32.

According to one aspect, interior 20 may further include a flap seal 142 on the inner face 44 of first side 12 corresponding to each of first slot 136, second slot 138, and third slot 140. According to this aspect, flap seal 142 can be fixedly attached at a top portion while the bottom portion remains unattached to first side such that when first, second, and third dividers 28, 30, and/or 32 are inserted through slots 136, 138, and 140, flap seal 142 can flex up and out of the way allowing first, second, and third dividers 28, 30, and 32 to pass. Further, according to this aspect, when first, second, and third dividers 28, 30, and 32 are removed, flat bottom portion of flap seal 42 may rotate down thereby closing slots 136, 138, and 140. According to one aspect, flap seal 142 may be constructed from any suitable material that is flexible enough to bend out of the way of dividers 28, 30, and/or 32 while having water resistant and/or water impermeable properties. By way of one non-limiting example, flap seal 142 may be constructed of a flexible rubber, such as a neoprene or other similar material.

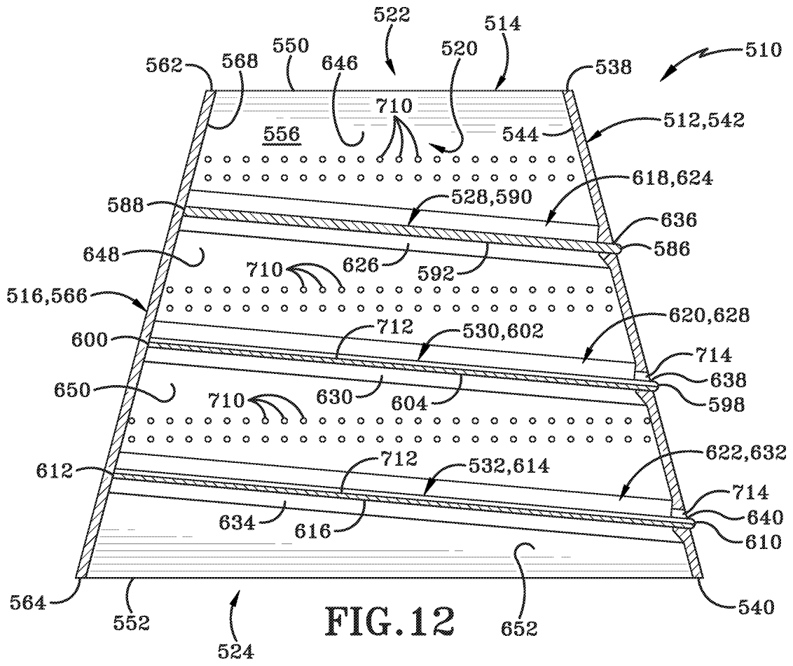

According to another aspect, slots 136, 138, 140 can be sealed using a plug seal 144, (shown in FIG. 12B) that can be inserted into slots 136, 138, 140 when dividers 28, 30, 32 are removed therefrom. Plug seal 144 may be a solid or semi-rigid strip of material that is sized to fit snugly within slots 136, 138, and/or 140 to prevent water from passing therethrough when dividers 28, 30, and/or 32 are not inserted therein.

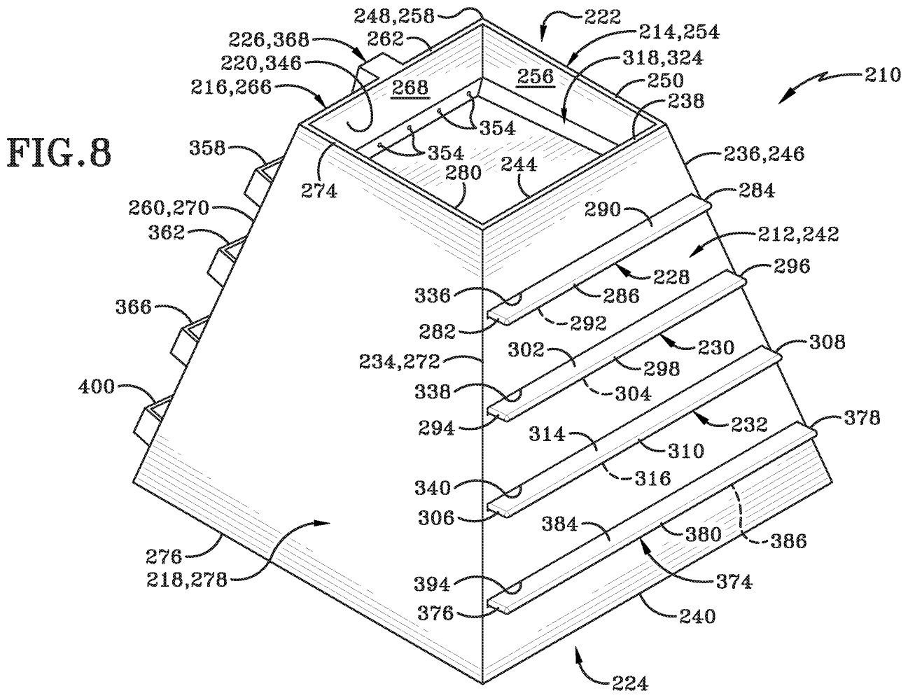

With reference to FIG. 8, an alternative embodiment of planter 10 is shown and generally indicated as planter 210. Planter 210 can have substantially the same structure and form as planter 10 with an added vertical height defined as the distance spaced between top edges 238, 250, 262, and 274 and bottom edges 240, 252, 264, and 276 of first, second, third, and fourth sides 212, 214, 216, and 218. This increased vertical distance can allow the inclusion of a fourth divider 374 which, similarly to first, second, and third dividers 228, 230, and 232, may include a left side edge 376 spaced apart longitudinally from a right side edge 378, a front edge 380 spaced apart horizontally from a rear edge 382, and a top face 384 spaced apart vertically from a bottom space 386.

According to this embodiment, interior 220 of planter 210 may further include a fourth channel 388 having a top portion 390 and a bottom portion 392 that are substantially similar to top portion 324, 328, and 332 and bottom portions 326, 330, and 334 of first, second, and third channels 318, 320, and 322.

Similarly, first side 318 may include a fourth slot 394 configured to accept fourth divider 374 similar to first, second, and third dividers 228, 230, and 232.

Fourth divider 374 may further define a fifth chamber 396 within interior 220 of planter 10. The fifth chamber 396 may be directly below fourth chamber 352 and may be defined by the bottom face 316 of third divider 232, a fifth portion of the inner faces 244, 256, 268, and 280 of first, second, third, and fourth sides 212, 214, 216, and 218, and the bottom 224 of planter 210. Fourth chamber 352 may then further include and be defined by the top face 384 of fourth divider 374.

As with planter 10, bottom 224 may be open or sealed according to the desired implementation of planter 210.

Further, according to this embodiment, drainage system 226 may further include a fourth left branch 398 and a fourth right branch 400 that may allow water to drain out of fourth chamber 352 similar to planter 10 and drainage system 26.

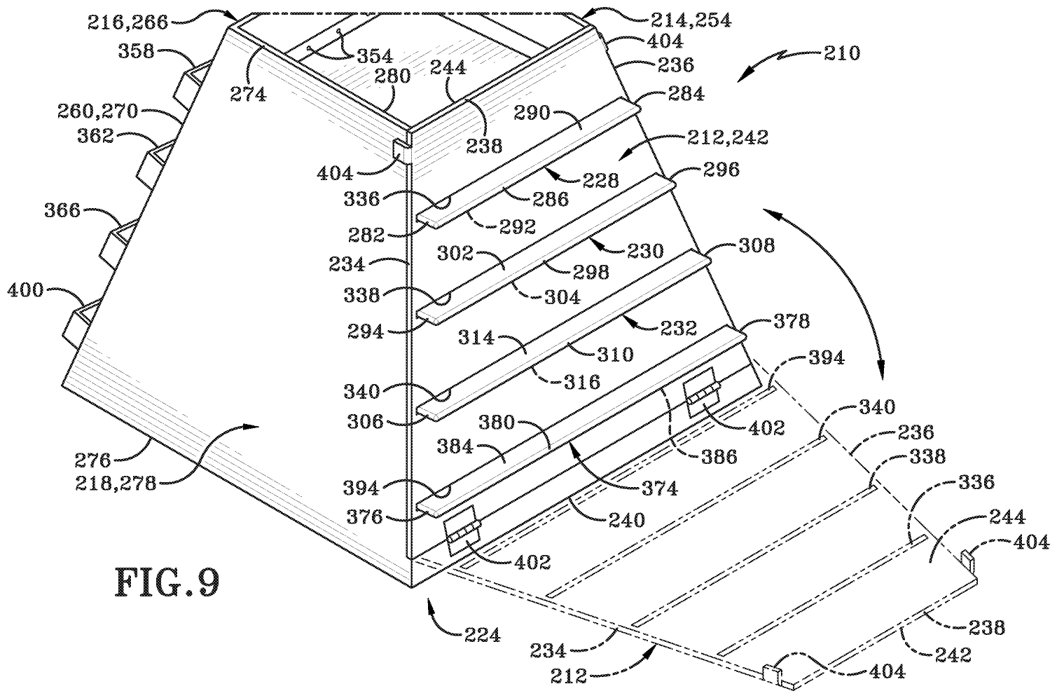

With reference to FIG. 9, planter 210 is shown having one or more optional hinges 402 and one or more optional latches 404 on one or more of sides 212, 214, 216, and/or 218. According to the embodiment shown in FIG. 9, hinges can be placed along bottom edge 240 of first side 212 while latches 404 may be placed at the upper portion of first side edge 234 and second side edge 236 of first side 12. Latches 404 can engage with the uppermost portion of second side 214 and fourth side 218 to secure first side 212 in place in a closed position while allowing first side 12 to be rotated about hinges 402 to a second, open position as illustrated in FIG. 9.

According to another aspect, hinges 402 may be placed along a side edge of one or more of sides 212, 214, 216, and/or 218. For example, hinges 402 may be places along one of first side edge 234 or second side edge 236 of first side 212 with latches 404 connected to the opposite side edge 234 or 236 of first side 212. This can allow first side 212 to pivot open relative to second side 214 or fourth side 218 of planter 210. It will be further understood that hinges 402 and latches 404 can readily and easily be adapted for use with planter 10 in an identical or similar manner.

Further, as described herein with reference to first side 212 (or first side 12), hinges can likewise be applied to any of first side 212, second side 214, third side 216, or fourth side 218 in a similar manner as described with reference to first side 212 without deviation from the scope herein.

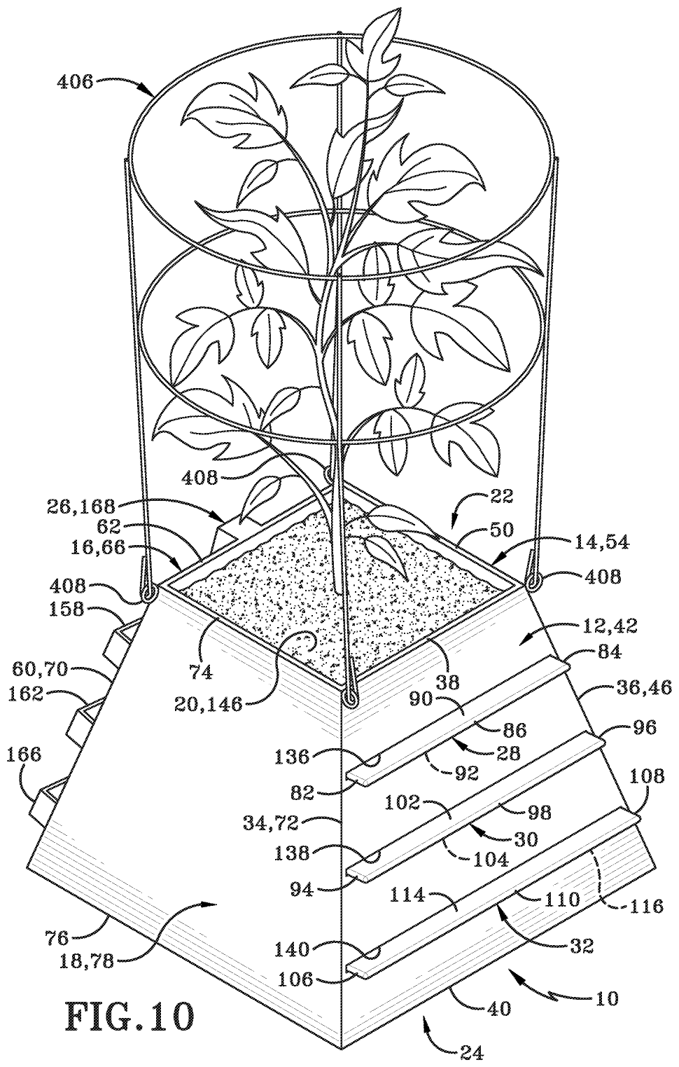

With reference to FIG. 10, planter 10 is shown having an optional frame 406 extending vertically from top 22 of planter 10. According to this embodiment, frame 406 can include an attachment point 408 at each corner, defined as the intersection between side edges of first, second, third, and fourth sides 12, 14, 16, and 18, that can allow frame 406 to be placed or removed as desired. According to this aspect, frame 406 can be configured to support an associated plant within planter 10 to allow proper growth thereof. Although shown with planter 10, it will be understood that frame 406 and attachment points 408 may be readily adapted for use with planter 210 as described herein.

According to one aspect, if planter 10 is anticipated for use with perennial plants or plants that are not intended to be permanently placed exterior of planter 10, fourth chamber 152 can be solid or otherwise permanently filled such that fourth chamber 152 is not used in operation. Similarly, planter 210 may have a solid or filled fifth chamber 396.

According to another aspect, if the plant being grown in planter 10 is anticipated to be transferred or placed in a location such as in a landscape where planter 10 will ultimately be removed from the plant being grown or the plant being grown will be removed from planter 10, fourth chamber 152 can be opened and continuous with the external environment. Similarly, fifth chamber 396 of planter 210 can be open and continuous.

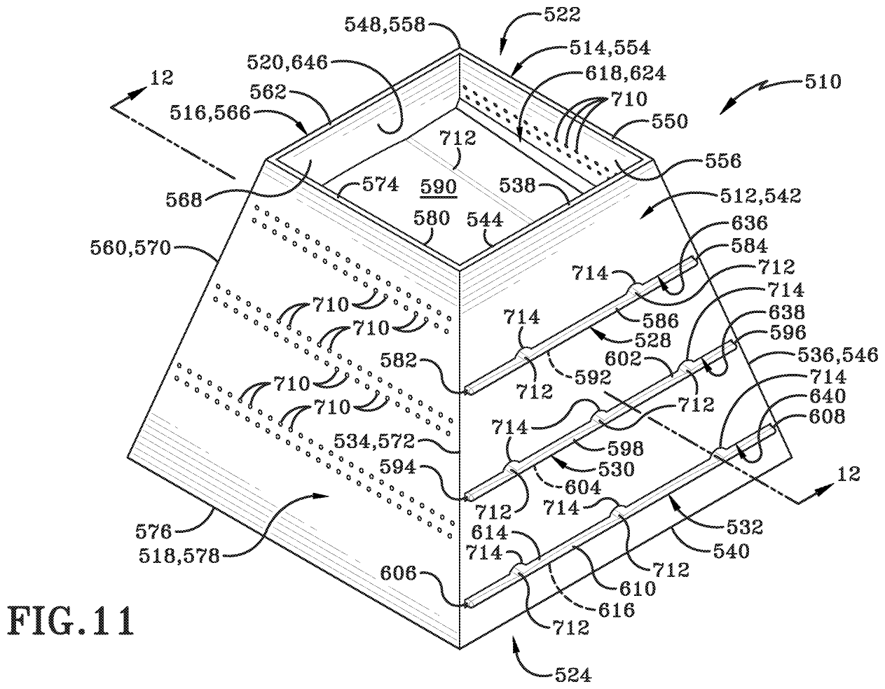

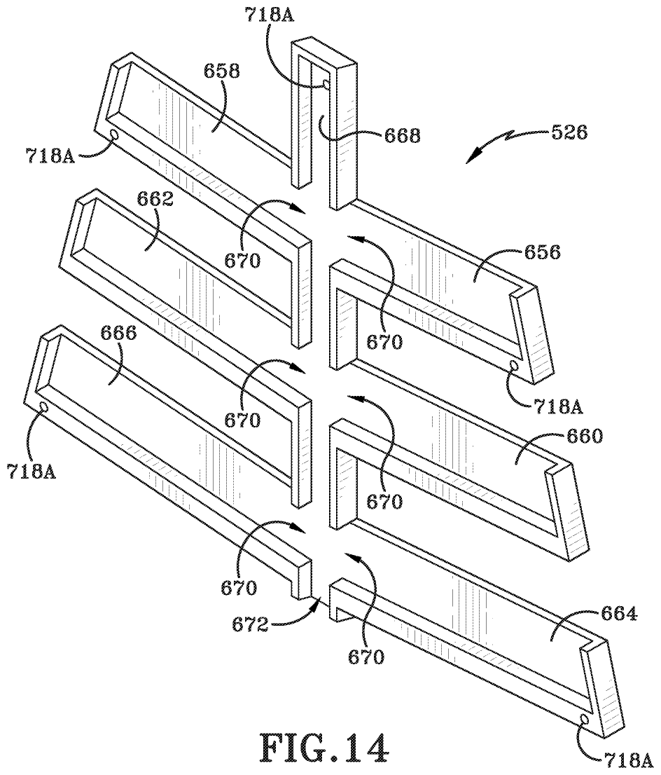

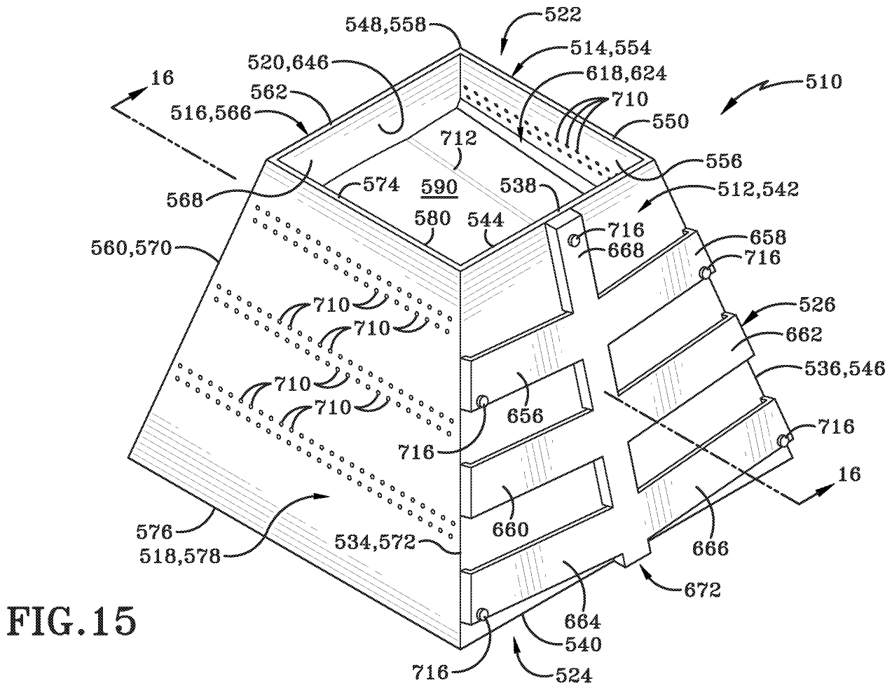

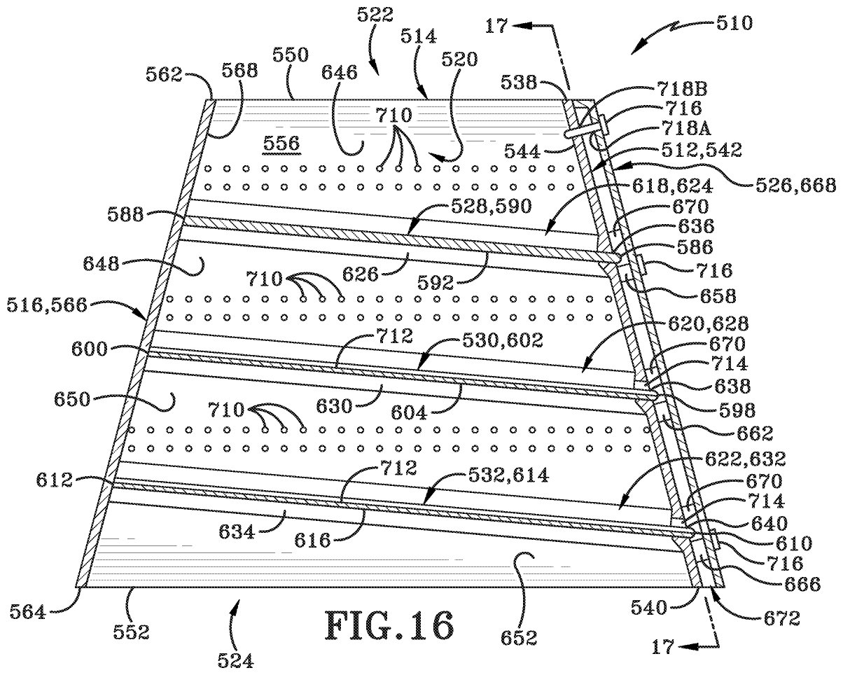

With reference to FIGS. 11-19D, a third embodiment of planter 10 is shown and generally indicated as planter 510. Planter 510 may be substantially similar to planters 10 and 210 in that planter 510 may have a first side 512, a second side 514, a third side 516, and a fourth side 518 and may generally take a four-sided pyramidal shape. Similarly, planter 510 may have a first divider 528, a second divider 530, and a third divider 532 disposed through a first slot 636, a second slot 638, and a third slot 640, respectively. Further, planter 510 may include a first channel 618, a second channel 620, and a third channel 622 which may engage first, second, and third dividers 528, 530, and 532, respectively.

Planter 510 may differ from planters 10 and 210 in the following aspects. First, where first, second, and third dividers 28, 228, 30, 230, 32, and 232 of planters 10 and 210 are sloped relative to the horizontal base plane from the front towards the back of planters 10 and 210, the dividers 528, 530, and 532 of planter 510 may be sloped relative to the horizontal base plane from the back to the front of planter 510. Additionally, planter 510 may omit or eliminate weep holes 154, 354 in the third side 16, 216. Instead, planter 510 may include a series of drainage openings 714 which may align with water channels 712 formed in dividers 528, 530, and/or 532 as discussed further herein.

Planter 510 may additionally differ from planters 10 and 210 in the inclusion of one or more aeration holes 710 formed in one or more sides, such as first side 512, second side 514, third side 516, and/or fourth side 518. The aeration holes 710 may be apertures defined through the thickness of first, second, third, and/or fourth sides 512, 514, 516, and/or 518 to allow free exchange of air moving in and out of first, second, third, and/or fourth chambers 646, 648, 650 and/or 652 of planter 510. The inclusion of aeration holes 710 may allow for evaporation of excess moisture that gets trapped within the chambers 646, 648, 650 and/or 652 as well as free exchange of oxygen and other gaseous nutrients with the root system of a plant being grown therein. Although illustrated in FIGS. 11-13 and 15-16 as being present only in second side, 514 and fourth side 518, it will be understood that aeration holes 710 may be included in any of the sides of planter 510, including first side 512, second side 514, third side 516, and/or fourth side 518. Further, although depicted in a pair of parallel rows per chamber, aeration holes 710 may have any arrangement or configuration as dictated by the desired implementation.

Planter 510 may further differ from planters 10 and 210 in that drainage system 526 may be removable therefrom. As best seen in FIGS. 13-15, drainage system may still include a central drain line 668 with first left and right branches 656, 658, second left and right branches 660, 662, and third left and right branches 664, 666 extending transversely therefrom. Central drain line 668 may include drain holes 670 which may allow water to transfer from the branches 656-666 into the central drain line 668. Central drain line 668 may further include a drain opening 672 at or near the bottom portion thereof to allow water collected by drainage system 526 to exit the central drain line 668. Removable drainage system 526 may be configured to place the first left and right branches 656, 658 across the opening created by first slot 636 while placing second left and right branches 660, 662 over second slot 638 and third and left right branches 664, 668 over third slot 640. This may allow water exiting each chamber of planter 510 through drainage openings 714 to collect within the branches of drainage system 526 to be directed down and outward therefrom.

Drainage system 526 may connect to first side 512 through a series of fasteners 716 and apertures 718. More particularly, drainage system 526 may include a first set of apertures 718A that are sized to accept fasteners 716 therethrough, while first side 512 may include a series of corresponding apertures 718B which may align with apertures 718A and likewise accept the fastener 716 therethrough. According to one aspect, fasteners 716 may be removable to allow drainage system 526 to be connected or disconnected as desired. According to this aspect, fasteners 716 may be snaps or clips that may extend through the first set of apertures 718A and may temporarily engage the second set of apertures 718B defined through first side 512. According to another aspect, fasteners may be any suitable fastening device including screws, nails, rivets, bolts, or the like. It will be understood that in operation, as discussed below, when dividers 528, 530, and/or 532 are to be removed from planter 510, the drainage system 526, if equipped, may likewise be removed by removing fasteners 716 from the apertures 718A, 718B to allow access to the dividers 520, 530, and/or 532, as discussed further herein.

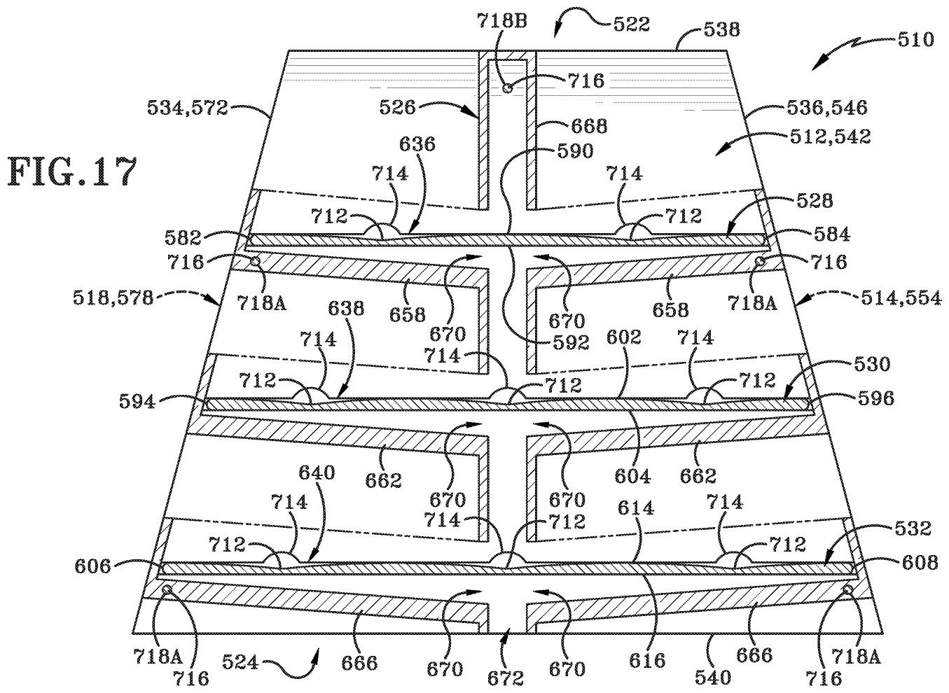

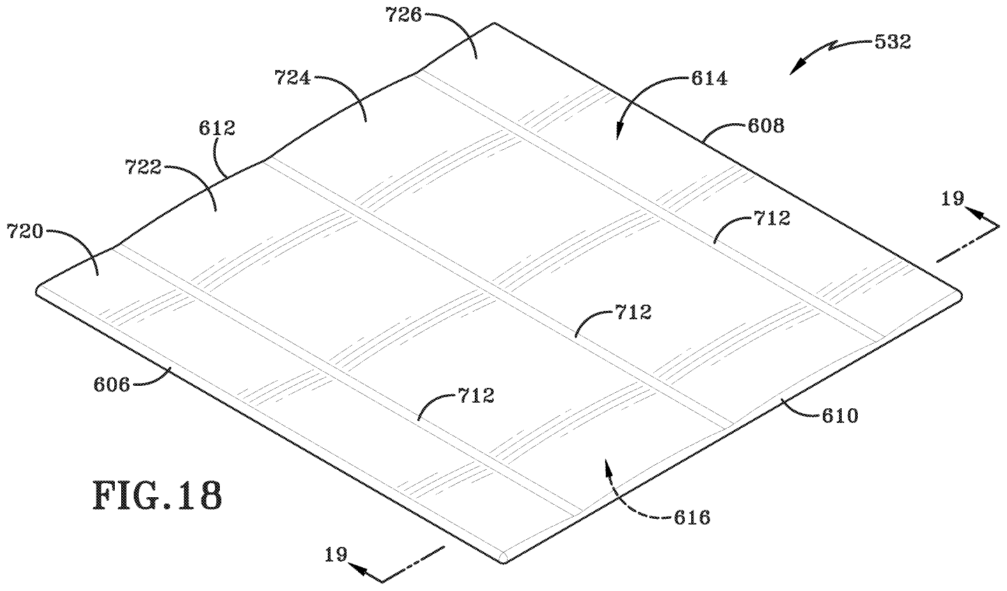

With reference to FIGS. 17 and 18, dividers 528, 530, and/or 532 may differ from dividers 28, 30, and/or 32 of planter 10 and dividers 228, 230, 232 of planter 210 according to the following aspect. Dividers 528, 530, and/or 532 may include one or more water channels 712 formed or defined in the top surface thereof. Specifically, first divider 528 may have one or more water channels 712 formed in a top face 590 thereof, while second divider 530 may have one or more water channels 712 formed in the top surface 602 thereof, and third divider 532 may have one or more water channels 712 formed in the top surface 614 thereof. These water channels 712 may be numbered and configured to match the number and configuration of drainage openings 714 formed through first side 512 above first slot 636, second slot 638, and/or third slot 640. These water channels 712 may facilitate excess moisture draining from the chambers 646, 648 and/or 650 of planter 510 and out through drainage openings 714 defined through first side 512, as discussed below.

With reference to FIG. 18, an exemplary divider is shown and indicated as third divider 532; however, it will be understood that first divider 528 and/or second divider 530 may share or have common features limited only by the chosen arrangement and number of water channels 712 formed in the top surface 614 thereof. Therefore, as depicted and discussed with reference to FIG. 18, the third divider 532 will be understood to be a representative example and not a limiting example of a divider of planter 510.

Accordingly, third divider 532 may include a series of raised intermediate portions between the water channels 712 (or between water channels 712 and the edges 606, 608 of the divider 532) to help direct water laterally within planter 510 and into water channels 712. Specifically, according to the example shown in FIG. 18, third divider 532 may include a first intermediate portion 720, a second intermediate portion 722, a third intermediate portion 724, and a fourth intermediate 726. The first intermediate portion 720 may extend horizontally from the left edge 606 to a first water channel 712. The second intermediate portion 722 may extend horizontally between a first water channel 712 and a second water channel 712, while a third intermediate portion 724 may extend between the second water channel 712 and a third water channel 712. Similarly, the fourth intermediate portion 726 may extend between the third water channel 712 and the right side edge 608 of third divider 532.

According to this aspect, first and fourth intermediate portions 720, 726 may be singularly sloped in that they may angle downward from the edges 606, 608 towards a centerline of third divider 532 to direct water away from the edges 606, 608 and sides 514, 518 of planter 510 and towards the water channels 712 formed in the top face 614 of third divider 532. Second and third intermediate portions 722, 724 may be crowned or peaked approximately half-way between water channels 712 to direct water both towards and away from the centerline of divider 532 and into water channels 712. These intermediate portions 720, 722, 724 and/or 726 coupled with water channels 712, drainage openings 714, and the overall back to front slope of third divider 532 may facilitate the movement of excess moisture out of the interior 520 of planter 510 to prevent root rot, mold growth, and/or other moisture related problems commonly associated with botany.

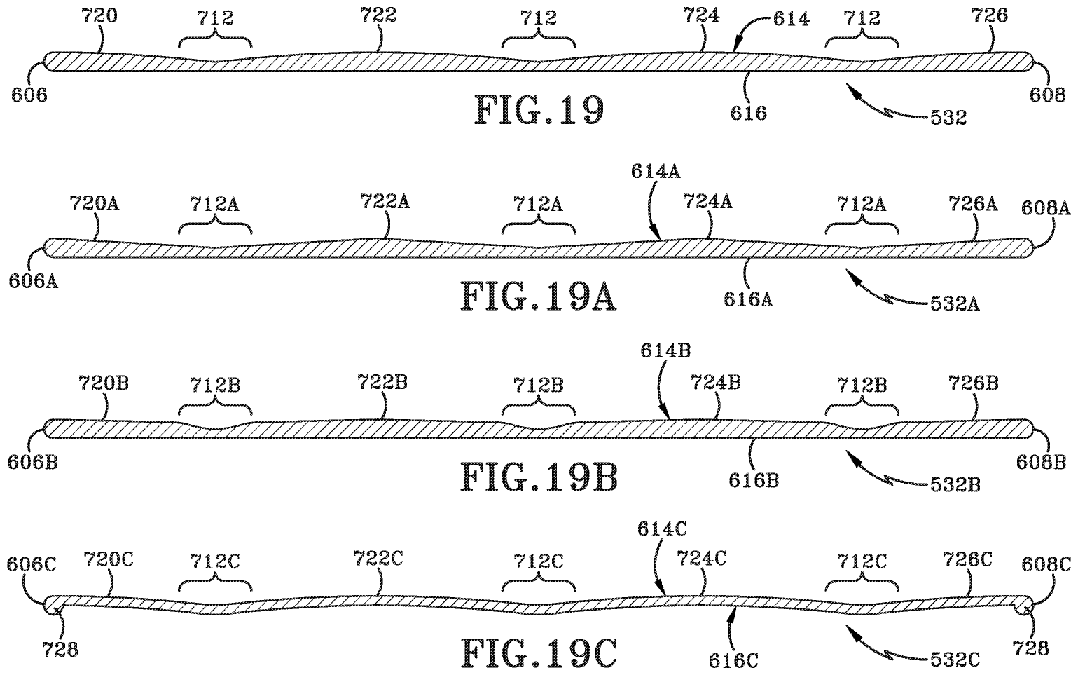

Although depicted in FIGS. 17 and 18 as having a flat bottom surface 616, third divider 532 and by extension, first and/or second dividers 528, 530, may have a cross-section with any suitable profile. For example, with reference to FIGS. 19-19C, various cross-sections of third divider 532 taken along the line indicated in FIG. 18 are shown having varying cross-sectional profiles.

Specifically, with reference to FIG. 19, third divider 532 may have a flat bottom surface 616 while first, second, third, and fourth intermediate portions 720, 722, 724, and/or 726 may have an arcuate or curved profile with water channels 712 disposed therebetween.

With reference to FIG. 19A, third divider 532A may likewise have a flat bottom surface 616A, while intermediate portions 720A, 722A, 724A and/or 726A may have a straight slope rather than a curved profile to direct water into channels 712A.

With reference to FIG. 19B, according to this example, divider 532B may likewise have a flat bottom surface 616B, but may have a flat or substantially flat top surface 614B with intermediate portions 720B, 722B, 724B, and 726B being substantially flat and relying on the overall front to back slope of third divider 532B to direct water out of interior 520 of planter 510. According to this example, water channels 712B may be curved or otherwise formed as depressions in the top surface 614B of third divider 532B with little to no additional modifications thereto.

According to another example, as shown in FIG. 19C, divider 532C may itself be shaped to provide the slope to intermediate portions 720C, 722C, 724C, and/or 726C such that the bottom surface 616C may parallel and mirror the top surface 614C and third divider 532C may have a corrugated or flattened wave shaped profile as a whole. According to this example, left and right edges 606C, 608C may include edge flanges 728 to facilitate the installation and removal of third divider 532C in third slot 640 to maintain a watertight relationship between third divider 532C and third channel 622.

As with the example in FIG. 18, although shown in FIGS. 19-19C as third divider 532-532C, it will be understood any dividers including first divider 528 and/or second divider 530 may likewise include similar profiles as the examples shown herein. It will be further understood that the examples illustrated in FIGS. 19-19D are non-limiting examples and the profile of dividers 528, 530 and/or 532 may be modified to include additional profile shapes, additional configurations and/or additional numbers of water channels 712 without deviation from the scope provided herein.

Planter 510 as with planters 10 and 210 may include any of the additional features as described with reference to the earlier embodiments, including but not limited to hinges 402, latches 404, frame 406, and/or attachment points 408. It will be further understood that planter 510 may include a fourth divider (not shown) disposed through a fourth slot (likewise not shown) defined through first side 512 to create a fifth chamber (not shown) within the interior 520 of planter 510. As with earlier planter embodiments 10, 210, planter 510 may be sized and configured for any suitable number of chambers as dictated by the desired implementation.

Similarly, planters 10, 210 may be modified to include features of planter 510 such as profiled dividers 28, 228, 30, 230, 32, and/or 232, as well as removable drain system 526, and/or aeration holes 710 as dictated by the desired implementation.

Having thus described the structure of planters 10, 210, and 510, a method of operation and use therefore will now be discussed.

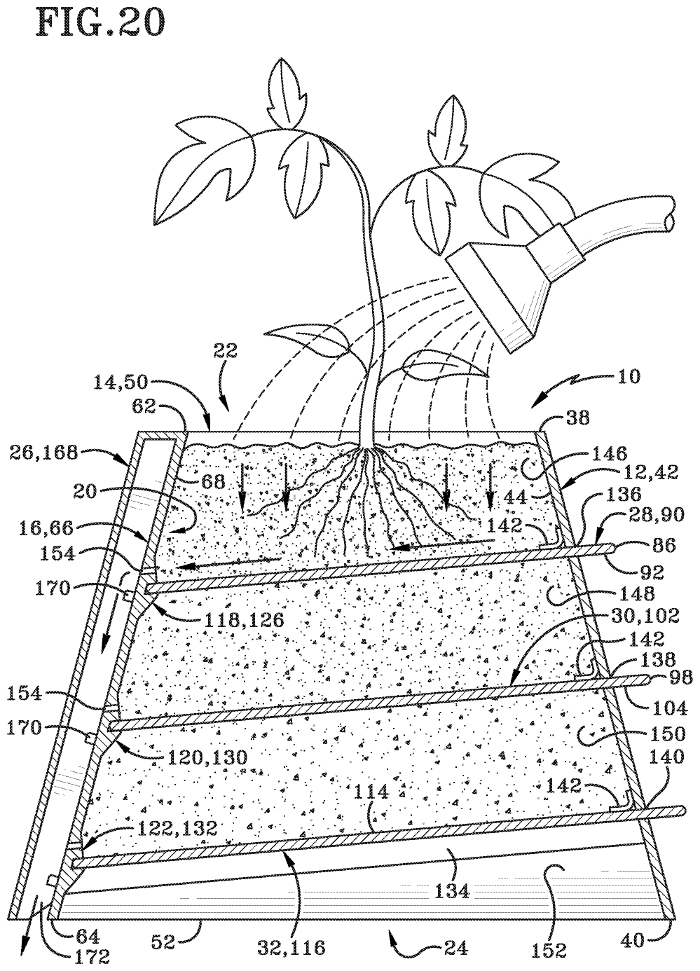

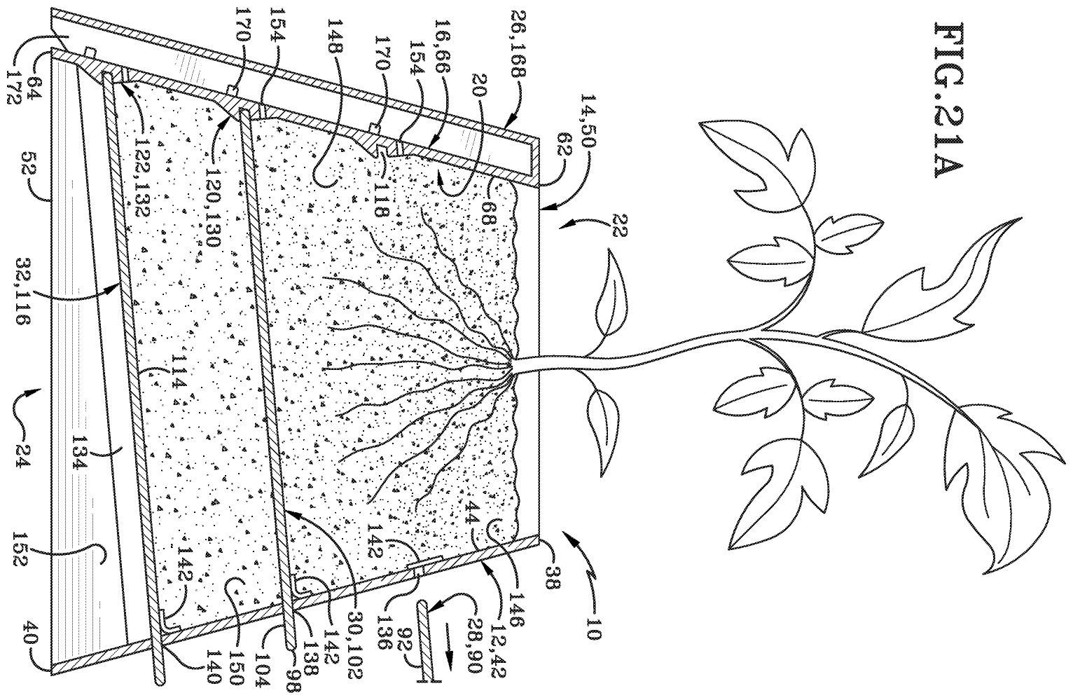

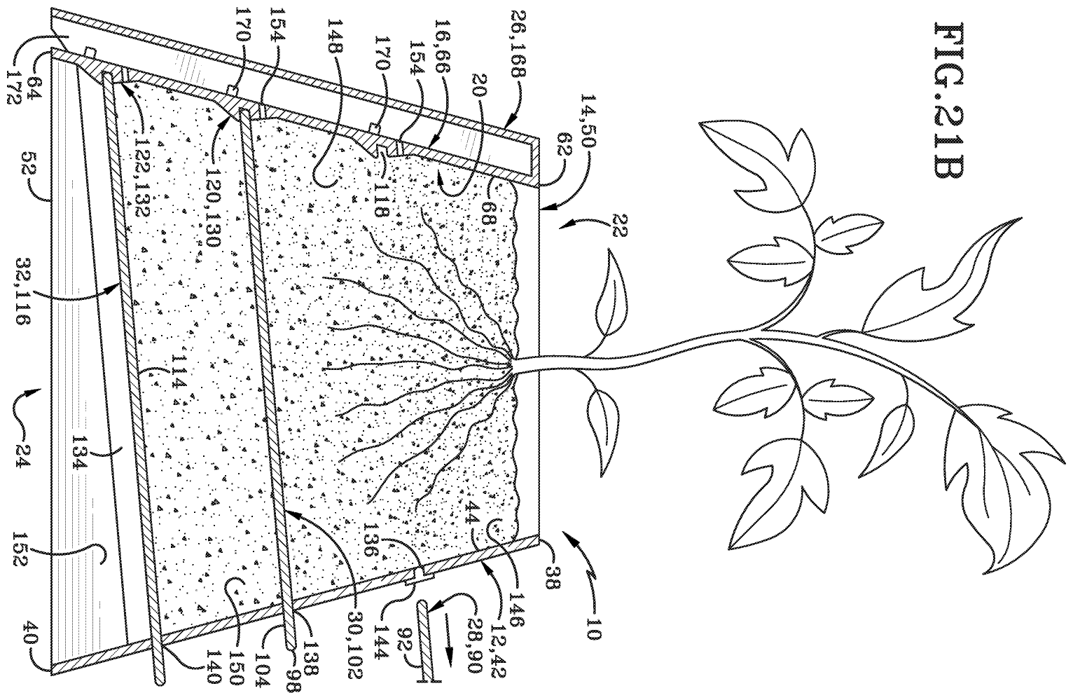

With reference to FIGS. 20, 21A, and 21B, the operation of planter 10 is now described. In operation, planter 10 can begin empty with first, second, and third dividers 28, 30, 32 removed such that interior 20 is open and continuous and first chamber 146, second chamber 148, third chamber 150, and fourth chamber 152 are in fluid contact. It will be understood that all embodiments of planters, i.e. planters 10, 201, and 510, may be similarly operated such that all steps or methods may apply equally to all embodiments, unless explicitly stated otherwise.

By way of an example, using planter 10 in an instance where the plant being grown is to be transferred to a permanent location or to a more permanent location at a later time, planter 10 can then be operated according to the following method: First, the third divider 32 can be placed through the third slot 140 and into third channel 122, thus creating the floor of the third chamber 150 and allowing a third soil mixture with a third nutrition to be placed on top. The third soil mixture with the third nutrition can be mixed and configured to provide nutritional needs to the plant in a third growth stage as the third soil mixture will be the last soil mixture the plant's root system will encounter prior to being transferred to another location outside of planter 10.

Once third chamber 150 is filled with a third soil mixture, second divider 30 can be inserted through second slot 138 and into second channel 120 thereby sealing off the top of third chamber 150 and creating a floor of second chamber 148. Second chamber 148, being directly above the third chamber 150, can now be filled with a second soil mixture and a second nutrition course. Similar to the third nutrition course, second nutrition is anticipated to fulfill the nutritional needs of the plant in a second growth stage.

Once second chamber 148 filled with the second soil mixture, the first divider 28 can be inserted through the first slot 136 and into the first channel 118 thereby sealing off the top of the second chamber 148 and creating the floor of the first chamber 146 within interior 20 of planter 10. At this point, a first soil mixture having a first nutrition can be placed within the first chamber. Again, the first soil mixture and first nutrition is anticipated to provide the nutritional needs of the plant during a first growth stage, which could begin as a seed or as a seedling.

The plant to be grown can now be placed within first soil mixture through convention means such as burying a seed or placing a seedling within a hole in the first soil mixture and covering the seed or the root system of the plant (as seen in FIG. 20. Planter 10 can be placed in a proper growing environment providing adequate sun and/or shade, the proper growing temperature, and/or humidity as required by the specific plant being grown.

To provide water to the plant, the grower can add water through the top 22 of planter 10 and into interior 20 of planter 10 through known means such as watering cans, drip mechanisms, hoses, sprayers, and the like.

According to another aspect, planter 10 can be placed in an outdoor environment where water can enter planter 10 naturally through rainfall or other water cycle mechanisms. Water entering planter 10 can be absorbed by the root system of the plant as needed by the specific plant being grown. Excess water can move through the soil mixture down through the first soil mixture, aided by gravity, where it can contact first divider 28. As first divider 28 is sloped front 86 to rear 88, excess water tends to be drawn to the rear of planter 10 where it can exit the first chamber 146 through one or more weep holes 154 and into the first left branch 156 or first right branch 158 of drainage system 26 where it can travel down the left and right branches 156, 158, through drain openings 172 and into center drain line 168. From here, water can travel down central drain line 168 and out drain line opening 172.

According to one aspect, water can be recycled from the opening 172 back into the top 22 of planter 10 via any suitable water transfer system, such as with a pump and hose mechanism (not shown). Alternatively, water can be collected as it exits drainage system through drain opening 172 and manually transferred back into planter 10.

According to another aspect, planter 10 can be placed on water permeable or water-absorbing substrates to allow dissipation of excess water as it drains out of planter 10. The placement of first divider 28 and presence of first channel 118 can direct all or substantially all of excess water through the weep holes 154 and out of planter 10 through drainage system 26. This can allow the second and third soil mixtures contained within second and third chambers 148, 150 to remain dry, which can further prevent the water from prematurely stripping the soil mixtures of nutrients distributed therein.

As the plant grows, the root system of the plant will expand. At a certain point, first chamber 146 will no longer be large enough to contain the root system of the plant. When the plant reaches this growth point and enters its second stage of growth, first divider 28 can be removed as shown in FIG. 12A thereby allowing the root system of plant access to the second soil mixture and second nutrition. Similar to first chamber 146, second chamber 150 is sealed by the second divider 30 and second channel 120 such that water entering the soil can be directed to the rear of planter 10, out through weep holes 154, and into drainage system 26 where it can be carried away or recycled.

When the root system of the plant being grown reaches a point where the combined first and second soil mixture volume is not sufficient, second divider 30 can be removed allowing the root system of the plant access to the third soil mixture and third nutrition within third chamber 150.

As with first and second chambers 146, 148, the third chamber 150 has dry soil containing all nutrients premixed within the soil mixture prior to planting and water passing through the now complete volume of soil can be directed by third divider 32 towards the third side 16 and out through weep holes 154 and drainage system 26 where it again can be discarded or recycled according to the grower's desired use.

As plant continues to grow and is ready for transfer to a location away from planter 10, planter 10 can be placed directly over the desired planting location and third divider 32 can be removed. This can allow the entire volume of soil, including first soil mix, second soil mix, and third soil mix, to fall through the fourth chamber 152 and out of the bottom 24 of planter 10, along with the plant being grown. Planter 10 can then be lifted up and over the plant to be removed.

According to one embodiment, if the upper portions of the plant being grown are expected to be of sufficient size as to prevent removal of planter 10 over the top of the plant, embodiments utilizing hinged doors as previously described can be used. According to this embodiment, at the point of plant transfer, latches 404 can be disengaged and one or more sides 12, 14, 16, and/or 18 can be rotated away from the neighboring sides 12, 14, 16, and/or 18 about hinges 402 to open planter 10 and allow planter 10 to be removed from the plant being grown.

For instances where planter 10 is anticipated to be the permanent or semi-permanent home of the plant being grown such that the plant will not be removed from planter 10 during its lifespan, the final step of transfer and removal of planter 10 may be omitted.

Alternatively, the fourth chamber 152 may be filled with a fourth soil mixture containing a fourth nutrition and at the point that the plant being grown reaches the appropriate size, the third divider 32 can be removed allowing the root system of the plant being grown to access this fourth soil mixture.

According to embodiments having five chambers, such as planter 210 having four dividers 228, 230, 232, and 374, and five chambers 346, 348, 350, 352, and 396, the operation of planter 210 can be substantially identical to operation of planter 10 with the exception of having an additional chamber and soil mixture accessible to the plant at the appropriate growth stage. For example, once the plant reaches the end of its third growth stage, where it would normally be transplanted, the fourth divider 374 may be removed and may allow the roots of the plant to reach a fourth soil mixture and fourth nutrition contained within fourth chamber 352. Once the plant outgrows the fourth chamber 352, the fourth divider 374 may be removed allowing the plant to be transferred out of planter 210, much like planter 10, or alternatively to access soil in the fifth chamber 396.

The operation of planter 510 may be substantially similar to the operation of planters 10, 210 in that a plant may be grown in successive chambers with the removal of dividers 528, 530, and/or 532 according to the methods of operation outlined above. The operation of planter 510 when equipped with removable drainage system 526 may slightly differ in that drainage system 526 must be removed to grant access to the dividers 528, 530, and/or 532 prior to the removal thereof. Accordingly, where planter 510 is utilized with drainage system 526 and the plant has reached a transitional point between growth stages, prior to removing the appropriate divider 528, 530, and/or 532, the grower must first remove fasteners 716 from apertures 718 to remove drainage system 526 from the first side 512. While not necessary to completely remove fasteners 716 from the first set of apertures 718A, the fasteners 716 need be removed at least from the second portion of apertures 718B to remove the drainage system 526 therefrom.

Once the grower has removed the appropriate divider 528, 530, and/or 532, drainage system 526 may be reinstalled on first side 512 by reinserting fasteners 716 through apertures 718A and/or 718B as appropriate.

As with planters 10, 210, once dividers 528, 530, and/or 532 are removed from planter 510, plugs such as flap seal 142 and/or a plug seal 144 may be utilized to seal slots 636, 638 and/or 640 when dividers 528, 530, and/or 532 are not disposed therethrough.

Although discussed with embodiments having three or four dividers creating four or five growth chambers, it will be understood that planters 10, 210, and/or 510 can be sized and configured to have any number of desired growth chambers as chosen by a person of skill relating to the needs of the plant being grown therein. Similarly, it will be understood that the method of use can be altered such that one or more chambers may not be used or may be used simultaneously without the divider according to the nutritional and growth needs of the plant being grown therein.

While discussed herein relating to various embodiments, it will be further understood that features described therein are interchangeable and can be equally applied to any and all embodiments without undue experimentation by a person of skill. It will be further understood that various features may be applicable to other embodiments not described herein but still within the scope of the disclosure herein. For example, other embodiments of planters 10, 210, and/or 510 may have a shape other than a four-sided pyramidal-shaped planter but may still employ similar or identical features.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The indefinite articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An apparatus for planting comprising:
a planter having a first side, a second side, a third side, an interior, and an exterior; and
at least one removable divider inserted through a slot defined through the first side of the planter, the divider operable to divide the interior into at least two separate chambers.

2. The apparatus of claim 1 wherein the at least one removable divider further comprises:
a first removable divider inserted through a first slot defined through the first side of the planter; and
a second removable divider inserted through a second slot defined through the first side of the planter;
wherein the first and second removable dividers are operable to divide the interior into at least three separate chambers.

3. The apparatus of claim 2 wherein the at least one removable divider further comprises:
a third removable divider inserted through a third slot defined through the first side of the planter;
wherein first, second, and third removable dividers are operable to divide the interior into at least four separate chambers.

4. The apparatus of claim 3 wherein the at least one removable divider further comprises:
a fourth removable divider inserted through a fourth slot defined through the first side of the planter;
wherein first, second, third, and fourth removable dividers are operable to divide the interior into at least five separate chambers.

5. The apparatus of claim 1 wherein the planter further comprises:
an open top; and
an open bottom.

6. The apparatus of claim 5 wherein the at least one removable divider further comprises:
at least one water channel defined in a top surface thereof operable to direct excess water out of the interior of the planter.

7. The apparatus of claim 6 wherein the slot defined through the first side of the planter further comprises at least one drainage opening in communication therewith, the at least one drainage opening aligned with the at least one water channel defined in the top surface of the at least one divider.

8. The apparatus of claim 7 further comprising:
a drainage system operably connected to at least one side and operable to direct water out of the interior of the planter to a location remote from the side.

9. The apparatus of claim 8 wherein the drainage system is removably attached to the at least one side.

10. The apparatus of claim 1 wherein the first, second, and third sides each further comprise:
a top edge with a first length; and
a bottom edge with a second length that exceeds the first length of the top edge.

11. The apparatus of claim 10 wherein the planter has a pyramidal shape.

12. The apparatus of claim 1 further comprising:
a plurality of aeration holes defined through at least one side of the planter with at least one aeration hole in communication with the interior of each of the at least two chambers.

13. A method of growing a plant comprising:
providing a planter having a first removable divider and a second removable divider;
inserting the second removable divider into the planter to form a second portion of an interior chamber of the planter;
filling the second portion of the planter with a second volume of soil;
inserting the first removable divider above the second volume of soil to isolate the second volume of soil from the remaining unfilled portion of the interior chamber and to form a first portion of the interior chamber of the planter;
filling the first portion of the interior chamber of the planter with a first volume of soil;
planting a plant in the first volume of soil;
removing the first divider from the planter when the plant grows to a first size;
allowing plant to continue to grow into the second volume of soil;
removing the second divider when the plant grows to a second size; and
releasing the first and second volumes of soil and the plant from the interior of the planter.

14. The method of claim 13 further comprising:
inserting a third removable divider into the planter to form a third portion of the interior chamber of the planter; and
filling the third portion of the planter with a third volume of soil prior to inserting the second removable divider into the planter.

15. The method of claim 14 wherein the second removable divider is above the third volume of soil to isolate the third volume of soil from the remaining unfilled portion of the interior chamber.

16. The method of claim 14 further comprising:
removing the second divider when the plant grows to the second size;
allowing plant to continue to grow into the third volume of soil;
removing the third divider when the plant grows to a third size; and
releasing the first, second, and third volumes of soil and the plant from the interior of the planter.

17. The method of claim 14 further having:
inserting a fourth removable divider into the planter to form a fourth portion of the interior chamber of the planter; and
filling the fourth portion of the planter with a fourth volume of soil prior to inserting the third removable divider into the planter.

18. The method of claim 17 wherein the third removable divider is above the fourth volume of soil to isolate the fourth volume of soil from the remaining unfilled portion of the interior chamber.

19. The method of claim 18 further comprising:
removing the third divider when the plant grows to the third size;
allowing plant to continue to grow into the fourth volume of soil;
removing the fourth divider when the plant grows to a fourth size; and
releasing the first, second, third, and fourth volumes of soil and the plant from the interior of the planter.

20. The method of claim 13 further comprising:
draining excess water from the first volume of soil while preventing water from contacting the second volume of soil via the first divider.
